(19) United States
(12) Patent Application Publication
(10) Pub. No.: US 2014/0372544 A1
(43) Pub. Date: Dec. 18, 2014

(54) System and Method for Establishing 2-Way Communications Between an App and a Browser

(71) Applicant: GTA Wireless Direct Ltd., Richmond Hill (CA)

(72) Inventor: Lijin "Michael" Wen, Richmond Hill (CA)

(21) Appl. No.: 14/306,644

(22) Filed: Jun. 17, 2014

Related U.S. Application Data
(60) Provisional application No. 61/956,736, filed on Jun. 17, 2013.

(51) Int. Cl. H04L 12/58

(52) U.S. Cl. CPC H04L 51/046
USPC 709/206

(57) ABSTRACT

A method is provided for receiving an instant message from a first user on a device of a second user irrespective of the device's installed applications or the second user's online status. A text message (addressed by the phone number of the second user's device) is received on the second user's device. The text message includes a link with a permanent unique token. When the link is actuated, a session is established of a dedicated web page on the second user's browser. The web page has a URL containing the permanent unique token. The instant message from the first user to the second user is displayed on the web page. The second user is then permitted to send a reply message to the first user via the web page. A server for enabling communication of an instant message is also provided.

### CROSS-REFERENCE TO RELATED APPLICATIONS

This application claims the benefit of U.S. Provisional Patent Application No. 61/956,736, filed Jun. 17, 2013 and entitled “System and Method for Establishing 2-Way Communication Between an App and a Browser,” which is incorporated herein by reference in its entirety.

### FIELD OF INVENTION

The invention relates to mobile device communications and more particularly relates to improved messaging for mobile devices across disparate platforms.

### BACKGROUND

Mobile devices have become an essential and inseparable part of the lifestyle. People use these devices for personal communications as well as for office communications, often carrying two or more separate devices e.g. a Smartphone and a tablet. Existing mobile devices e.g. phones, Smartphones, tablets and the like, have a multitude of functions that provide connectivity and communications services to a user. These devices are becoming increasingly smaller and more powerful and are used for making phone calls, checking e-mail, getting directions, playing games, searching the web, searching for places of interest on a map, amongst a host of other things.

In the past several years IP-based communication technology and end user device have evolved to enable many different communication possibilities thus introducing several new services. As an example SMS has evolved from short text string messages that were limited in size to messaging services that enable the delivery of multimedia content without any restrictions on size or type of content.

Devices, mobile or otherwise, are often also used for messaging. Different messaging applications exist that provide mechanisms for messaging. Some examples are Yahoo Messenger, Skype, MSN, Viber, BBM (Blackberry Messenger), FaceTime, Whatsapp, etc.

Instant Messaging provides instant communication with another individual or group of individuals utilizing the Internet as a medium between two or more devices that are connected to the internet. Such devices may include Smartphones, tablets, desktop PC, a laptop, a simplified PC for Internet connectivity, SmartTV, etc. When a user is utilizing an Instant Messaging application, it may include other areas for messaging like a dialog box and a buddy list that shows a user-created collection of possible instant messaging recipients that are using the same application and have added the user in their list of buddies.

A buddy list allows a user to keep a track of possible Instant Messaging recipients who are online, thus letting the user know when her buddies come online or go offline. When a user wishes to send an Instant Message to someone on a buddy list, the user selects the desired address from the buddy list and enters a message into a dialog box. When the user presses the send button, a window immediately opens on the screen of the recipient with the Instant Message. The recipient can then respond by entering a message into the dialog box and pressing send. This continues as long as both individuals wish to have a conversation. Prior art instant messaging applications only allow individuals using the same application to be included on a buddy list. Additionally messaging is also limited with respect to both parties having to have the same application installed on their respective devices.

There are a number of shortcomings and limitations in the prior art instant messaging processes and systems. For example a user must know that the other party with whom they wish to communicate with a messaging application has the same application installed on their device. They also must know that the other party is online and the messaging app that they are using is running. Such limitations are also faced when messaging on tablets or other computing devices.

Thus both parties require the same application installed and must know that they are online and messaging app is running at both ends, in order to send and receive messages. By overcoming these limitations of the prior art, the present invention seeks to make instant messaging more accessible and convenient for users without compromising security and privacy.

### SUMMARY

Broadly stated, the present invention provides a method for establishing a secure 2-way communications between a first device and a second device without requiring that the two said devices have the same application installed for messaging. The first party only needs to know the phone number of the second party to send a message and does not need to know that the second party is using the same messaging app or is online with the messaging app running.

Devices that can advantageously make use of the system of the invention may include but are not limited to a Smartphone, a tablet, a computer, a server, a network appliance, a set-top box, a SmartTV, an embedded device, a computer expansion module, a personal computer, a laptop, a tablet computer, a personal data assistant, a game device, an e-reader, any other mobile or stationary device or any appliance having internet or wireless connectivity.

To illustrate, an application (app) may be installed on a first device. The app is able to send a message and receive a response from a second device that does not have the said app installed on it. Thus the first device can establish a 2-way communications with a second device assisted by a server.

According to a first aspect of the invention, a method is provided for receiving an instant message from a first user on a device of a second user irrespective of the device's installed applications or the second user's online status. A text message (addressed by the phone number of the second user's device) is received on the second user's device. The text message includes a link with a permanent unique token. When the link is actuated, a session is established of a dedicated web page on the second user's browser. The web page has a URL containing the permanent unique token. The instant message from the first user to the second user is displayed on the web page. The second user is then permitted to send a reply message to the first user via the web page.

Although point-to-point (2-way) communications are discussed herein for the sake of simplicity, it will be understood that the present methods and systems may also apply mutatis mutandis to situations where there may be more than two participants in the communication session. Thus the invention can be used for one-to-one communications as well as can be used for one-to-many communications.

The instant message may include at least one of: a text component, a picture component, an audio component, a video component, a hypertext component, a multimedia component, and a GPS location component. Once the 2-way communication session has been established between the first device that has an app installed on it and a second device that is using a browser, the content that may be exchanged between the devices may preferably be text, picture, audio, video, hypertext, GPS location, or any other kind of digital content that can be shared or exchanged.

In some embodiments, the instant message may be encrypted. That is, the content that is exchanged between the first device and the second device may be encrypted; the encryption may be either on the server side or the client side.

In some embodiments, the text message may be SMS. Other formats of messages may also be supported. In some embodiments, the instant message may include more than 160 characters.

Preferably, the permanent unique token is embodied in an HTTP cookie that is stored on the second user's device. Preferably, the session is kept alive as long as the second user is logged in to the browser, or until the second user ceases activity in the browser for a predetermined period of time.

In some embodiments, the first user's presence status may also be displayed on the web page of the second user's browser. For example, the second user may be able to send a push message to the first user through the web page if the first user is not present. In this case, the push message may be sent to an instant messaging application on the first user's device.

In some embodiments, a history of messages between the first user and the second user exchanged during the session may also be displayed. For example, the messages may be displayed as a continuous thread.

According to a second aspect of the invention, a server is provided for enabling communication of an instant message from a first user to a device of a second user irrespective of the device's installed applications or the second user's online status. The server includes programmed instructions. Data is received from an app on the first user's device including an instant message to be sent to a second user (this may be or include, for example, an uploaded file). The data includes a phone number of a device of the second user. The server creates a permanent unique token for the second user. The server sends a text message to the second user with a URL containing the permanent unique token. The second user is then allowed to access a dedicated web page with the URL. The instant message is displayed on the web page. The second user is allowed to send a reply to the first user via the web page.

The server may also look up the phone number of the device in a database and if not found then create an account using the phone number and the permanent unique token.

Sending a “text” message in this case is not necessarily limited to standard text messages (e.g. SMS), but also includes sending a push notification, or sending a message to an application (e.g. an instant messaging application) on the second user's device. In one embodiment, the application is a browser.

The server may check that the application is installed on the second user's device prior to sending a message to that application.

The server may check that the second user is online or that the application is open prior to sending a message to the application.

Preferably, the contents of the instant message are not part of the text message.

### BRIEF DESCRIPTION OF THE FIGURES

FIG. 1 is a flow diagram of a process for sending a message between a User1 (first user) and a User2 (second user).

FIG. 2 is a flow diagram of one embodiment of a process for creating a message to be sent according to the process of FIG. 1.

FIG. 3 is a flow diagram of a sample process for creating an anonymous message to be sent according to the process of FIG. 1.

FIG. 4 is a flow diagram of an alternative method of creating a message using a desktop browser.

FIG. 5 is a flow diagram of a preferred process for receiving and optionally responding to the message.

### DETAILED DESCRIPTION

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

The invention may also be implemented as a SaaS (Software As A Service) architecture using any variation and combination of cloud technologies and services bring provided by companies like Amazon, Google, Microsoft etc.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the console where it is read. The console can then read program instructions stored on the storage media and present a user interface to the user.

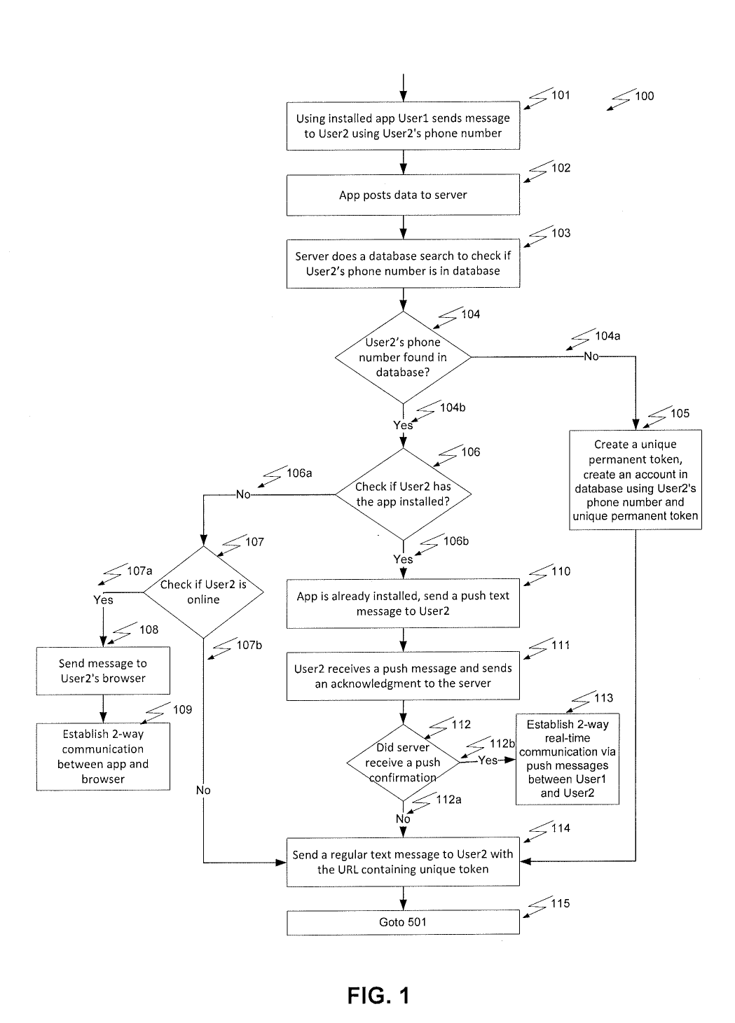

FIG. 1 illustrates a process for sending a message according to a preferred embodiment of the present invention.

A system is provided for messaging for devices mobile or otherwise whereby using installed app User1 sends message to User2 using only User2's phone number 101. For example, the system and method may be implemented on a mobile device like a Smartphone, a tablet, a computer, a laptop a SmartTV or the like. Devices where invention can be advantageously implemented may include but not limited to an iPhone, iPad, Smartphones, Android phones, personal computers e.g. laptops, tablet computers, touch-screen computers running any number of different operating systems e.g. MS Windows, Apple iOS, Linux, Ubuntu, etc. or any other device where a internet connection can be supported using technologies like 3G, 4G, LTE, WiFi, Bluetooth, NFC etc.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

Preferably, the first user installs (or has installed) an application that embodies the invention on a first device. The app posts data to the server 102. The application may have more than one version, where each particular version is intended for a particular operating system. For example there may be a version of the application for iOS that can be installed on iPhone and iPad, while there may be another version of the application that can be installed on an Android device. The first device (i.e. the first user's device) and the second device (i.e. the second user's device) may have the same operating system e.g. the first device is an iPhone while the second device is an iPad or the first device and the second device may have different operating systems e.g. the first device is an Android phone while the second device is a laptop running Microsoft Windows 7.

The server does a database search to check if User2's phone number is in its database 103. The server is a specially-programmed computing device that is connected to the internet or other network and is capable of providing a communication service to devices and applications that connect to it via the network. The server stores a program executable by a computer included in a server. In this case, the executable program manages the database of users, and inter-user communications and other functions and routines necessary to execute the functionality of the invention.

Apart from its special programming for the present invention, the server hardware is similar to an ordinary personal computer. A typical server for use with the present invention would comprise a central processing unit (CPU), a memory, and input/output (I/O) equipment, which are connected by a bus inside. Through north bridge chips, the CPU and the memory are connected, and through south bridge chips, the I/O dock is connected.

The server checks whether User2's phone number is found in database 104. If No, User2's phone number is not found in the database 104a, then the server creates a unique permanent token, and creates an account in the database that will be associated with User2's phone number and the unique permanent token 105.

If User2's phone number is found in the database 104b, then the server checks whether User2 has the same application installed on his device 106.

If No 106a, User2 does not have the same application installed on his device then the server checks if User2 is online 107. If Yes 107a, User2 is online then the server sends a message to User2's browser 108. A 2-way communication is established between app and browser 109.

If No 107b, User2 is not online then the server sends a regular text message to User2 with a URL containing the unique token 114.

The term text messaging also known as “SMS” stands for short message service which is a text messaging service component of phone, web, or mobile communication systems, using standardized communications protocols that allow the exchange of short text messages between fixed line or mobile phone devices.

SMS is a method of communication that sends text between mobile phones, or from a PC or handheld to a mobile phone. The “short” part refers to the maximum size of the text messages: in GSM 160 characters (letters, numbers or symbols in the Latin alphabet); in CDMA 140 characters; and for other languages that require double-byte alphabets, such as Chinese, the maximum SMS size is 70 characters.

If Yes 106b, User2 has the same application already installed on his device, then the server sends a push text message to User2 110.

User2 receives a push message and sends an acknowledgment back to the server 111. Push notification allows an app to notify a user of new messages or events without the need to actually open the application, similar to how a text message will make a sound and pop up on a mobile device screen. It presents a way for apps to interact with users while remaining in the background. Push notifications are widely used by a variety of apps including games to notify users of a message or a notification that an event is occurring in the app or for example iPad's mail application beeping as a new message appears in the inbox.

The server checks whether the server received the push confirmation (acknowledgment back) 112. If Yes 112b, the server received the push confirmation from User2's device then the server establishes a 2-way real-time communication via push messages between User1 and User2 113.

If No 112a, the server did not receive the push confirmation from User2, then the server sends a regular text message to User2 with the URL containing unique token 114. Next 115 go to step 501.

A computer executing a browser, also referred to as a Web Client or client, is essentially a hyper text reader communicating with a Web Server via a specific data transfer protocol such as a Hyper Text Transfer Protocol (HTTP). Any hyper text file on the web is uniquely identified by its Universal Resource Locator (URL). Many of the hyper text files are structured using the Hyper Text Mark-up Language (HTML) which may also be used for calling hyper text data objects. A hyper text data object may be in the form of any information medium including a text, an image, a voice, a moving picture or an executable computer program. When a client requests a hyper text file, using the file's URL, the file is displayed on the client's browser, where the display is commonly known as a web page. The client can return data to the server and call a Common Gateway Interface (CGI) program on the server computer to perform a specific task.

If the identity of the client is not needed, an HTTP server will serve content to any client which requests a page. Such a solution is only practical where the content is public and the author of the content may not want to place any restrictions on who may view the page. If the author of the linked-to page wants to place restrictions, the client will have to enter into a session with the server where the client is first authenticated prior to the server allowing access to the server.

Since HTTP is stateless and since Web servers are accessible by many users, where each user may interact with the Web server in a different way, a technique had to be developed in a way to track the states of the connecting users. Instead of requesting each user to authenticate upon each click in a Web application, a session token is created on the client's browser, where the session token is used to identify the user. Thus a session token is a unique identifier that is generated and sent from a server to a client to identify the current interaction session. The client usually stores and sends the token as an HTTP cookie and/or sends it as a parameter in GET or POST queries. The reason to use session tokens is that the client only has to handle the identifier—all session data is stored on the server (usually in a database, to which the client does not have direct access) linked to that identifier.

Usually the session token is kept “alive” in the browser as long as the user is logged on to the Web server. In some cases the session token may be deleted when the user logs-out from the Web Server or after a predefined period of inactivity. Typically session tokens are commonly stored in cookies, URLs and hidden fields of Web pages.

Devices that can benefit from the system of the invention may include but are not limited to a computer, a server, network appliance, set-top box, SmartTV, embedded device, computer expansion module, personal computer, laptop, tablet computer, personal data assistant, game device, e-reader, a mobile device for example a Smartphone, any appliance having internet or wireless connectivity.

Once a 2-way communication session has been established between User1 and User2, the users can share any kind of content such as text, hypertext, audio, video, data, or anything in a digital format (i.e. not necessarily a message of 160 textual characters or less). The content may be unencrypted or encrypted either at the server-side or at the client-side. Such messaging may preferably be used with any kind of environment be it related to work, home, business or other.

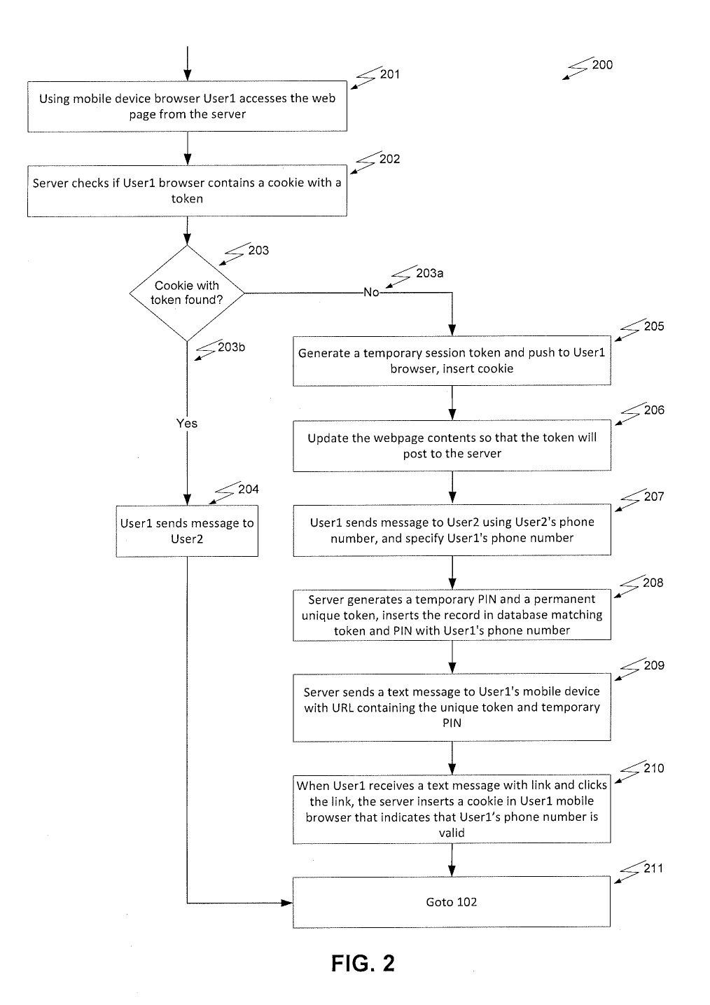

FIG. 2 shows one embodiment of the invention. Using mobile device browser User1 accesses the web page from the server 201. Server checks if User1's browser contains a cookie with a token 202.

A cookie, also known as an HTTP cookie, web cookie, or browser cookie, is a small piece of data sent from a web server (website) and stored in a user's web browser while a user is browsing a website. When the user browses the same website in the future, the data stored in the cookie is sent back to the web server by the browser to notify the web server of the user's previous activity.

Cookies were designed to be a reliable mechanism for web servers to remember the state of the website or activity the user had taken in the past. This can include clicking particular buttons, logging in, or a record of which pages were visited by the user even months or years ago.

When a user accesses a website with a cookie function for the first time, a cookie is sent from the server to the browser and stored with the browser in the local computer. Later when that user goes back to the same website, the web server will recognize the user because of the stored cookie with the user's information.

A session identifier, session ID or session token is a piece of data that is used in network communications (often over HTTP) to identify a session. A session is a series of related message exchanges. Session identifiers become necessary in cases where the communications infrastructure uses a stateless protocol such as HTTP.

For example, a buyer who visits a seller's site wants to collect a number of articles in a virtual shopping cart and then finalize the shopping by going to the site's checkout page. This typically involves an ongoing communication where several webpages are requested by the client and sent back to them by the server. In such a situation, it is vital to keep track of the current state of the shopper's cart, and a session ID is one way to achieve that goal.

A session ID is typically granted to a visitor on his first visit to a site. It is different from a user ID in that sessions are typically short-lived (they expire after a preset time of inactivity which may be minutes or hours) and may become invalid after a certain goal has been met for example, once the buyer has finalized his order, he cannot use the same session ID to add more items.

A session ID is often a long, randomly generated string to decrease the probability of obtaining a valid one by means of a brute-force search. Many servers perform additional verification of the client, to prevent an attacker from obtaining a session ID. Locking a session ID to the client's IP address is a simple and effective measure as long as the attacker cannot connect to the server from the same address.

A session token is a unique identifier, usually in the form of a hash generated by a hash function that is generated and sent from a server to a client to identify the current interaction session. The client usually stores and sends the token as an HTTP cookie and/or sends it as a parameter in GET or POST queries. The reason to use session tokens is that the client only has to handle the identifier (a small piece of data which is otherwise meaningless and thus presents no security risk)—all session data is stored on the server (usually in a database, to which the client does not have direct access) linked to that identifier.

The system checks whether a cookie with a token was found 203. If Yes 203b, the cookie with token was found in the browser of the device that User1 is using, User1 sends the message to User2 204. Next step 211 go to step 102.

If No 203a, the cookie with token was not found in the browser of the device that User1 is using, then the server generates a temporary session token and pushes it to User1's browser, and inserts a cookie in the browser 205. The server updates the webpage contents so that the token will post to the server 206.

User1 sends a message to User2 using User2's phone number, and specifies User1's phone number in the “From” field 207.

The server generates a temporary PIN and a permanent unique token, and inserts the record in the database matching token and PIN with User1's phone number 208.

The server sends a text message to User1's mobile device with URL containing the permanent unique token and temporary PIN 209. When User1 receives a text message with link and clicks the link, the server inserts a cookie in User1's mobile browser that indicates that User1's phone number is valid (since now it has been authenticated) 210. Next step 211 go to step 102.

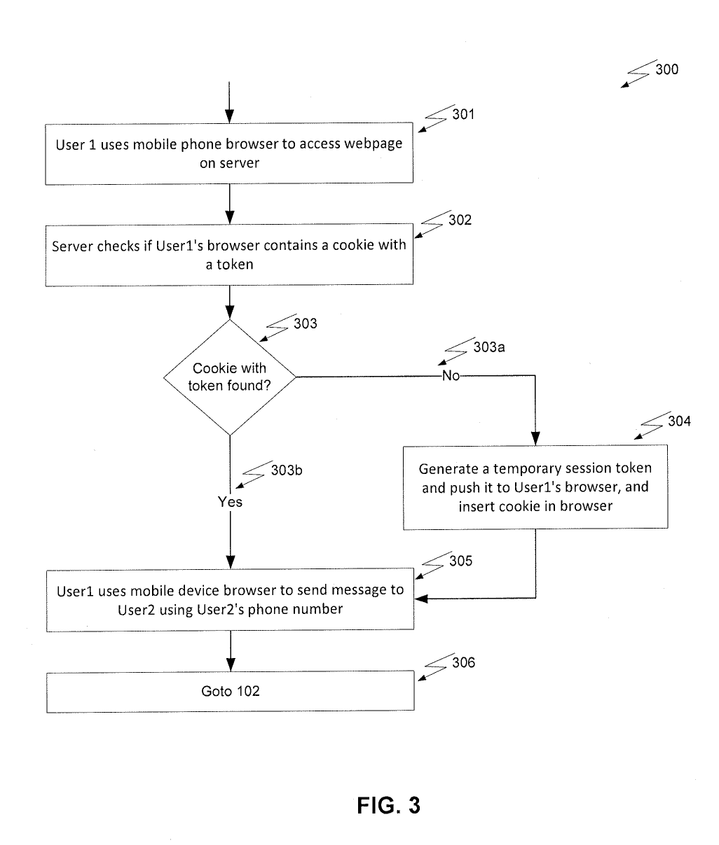

FIG. 3 shows an exemplary scenario 300 where a first user, User1 can send a message to User2 anonymously. User1 uses mobile device browser to access web page on the server 301. The server checks if User1's browser contains a cookie with a token 302.

The server checks whether a cookie with a token was found 303. If Yes 303b, the cookie with the token was found in the browser of the mobile device of User1, then User1 uses mobile device browser to send a message to User2 using User2's phone number in the “To” field of the form 305 (but User1 does not have specify User1 phone number in the “From” field of the form). Then next step 306 go to step 102.

If No 303a, a cookie with token was not found in the browser of the mobile device of User1, then the server generates a temporary session token and pushes it to User1's browser, and inserts cookie in the browser 304. User1 uses mobile device browser to send a message to User2 using User2's phone number in the “To” field of the form 305 (but User1 does not have specify User1 phone number in the “From” field of the form). Then next step 306 go to step 102.

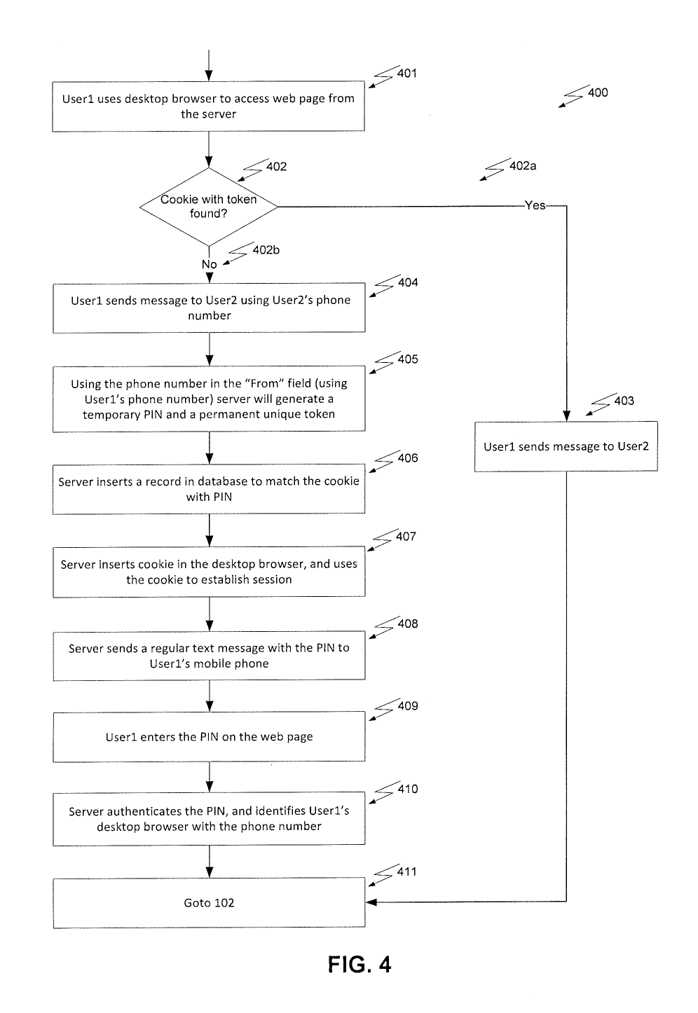

In an alternate embodiment of the invention 400 shown in FIG. 4; the first user, User1 can use a desktop browser to send a message to a second user, User2, by only providing User2's phone number. In such an embodiment the major difference is that the device (e.g. a tablet or a SmartTV) does not have a phone number associated with it; or that phone functionality is not built into such a device. Other such devices e.g. an iPad, a TV, and internet appliance, a game console etc. that has a browser and can connect to the internet using wired or wireless internet access can advantageously use this embodiment of the invention.

User1 uses desktop browser to access web page from the server 401. The server checks if a cookie with a token is present in the web browser of User1. The server determines whether a cookie with a token was found 402. If Yes 402a, a cookie with token was found in the desktop browser of User1, then User1 sends a message to User2 403. Then next step 411 go to step 103.

If No 402b, a cookie with token was not found in the desktop browser of User1 then the server presents a form using which User1 can specify the “From” and “To” fields. User1 sends message to User 2 using User2's phone number 404.

Using the phone number in the “From” field (User1 phone number) the server will generate a temporary PIN and a permanent unique token 405. The server inserts a record in the database to match the cookie with the PIN 406. The server inserts the cookie in the desktop browser, and uses the cookie to establish a session 407.

The server sends a regular text message with the PIN to User1's mobile device 408 in order to authenticate User1's mobile number. User1 enters the PIN on the web page 409.

The server authenticates the PIN, and identifies User1's desktop browser with the phone number provided by User1 410. Then next step 411 go to step 102.

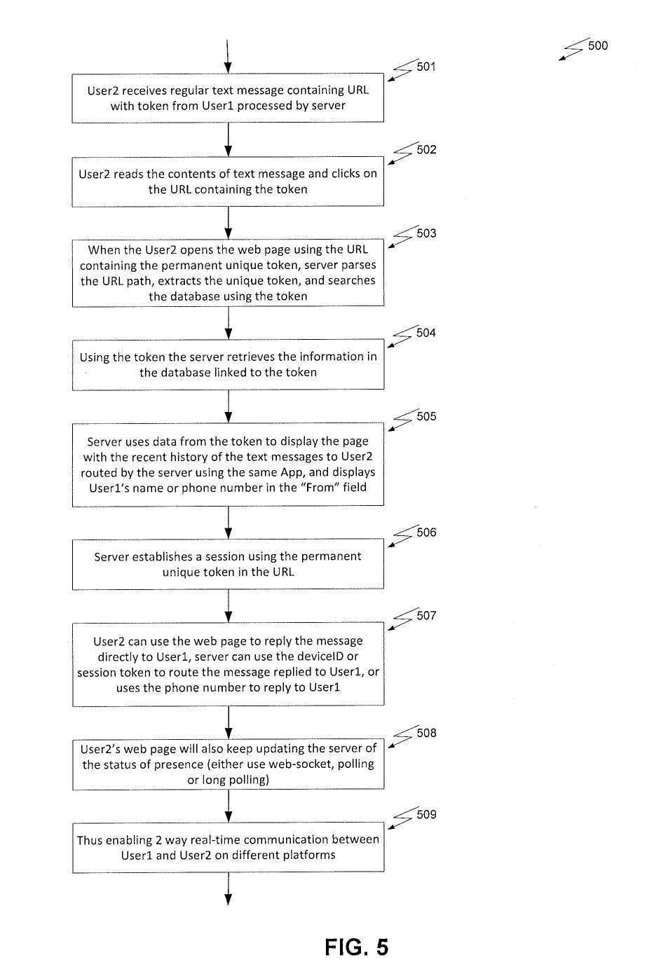

FIG. 5 shows the steps 500 that User2 takes. User2 receives a regular text message containing a URL with the token from User1 which has been processed by the server 501.

User2 reads the contents of the text message and clicks on the URL containing the token 502. When User2 opens the web page using the URL containing the permanent unique token, the server parses the URL path, extracts the unique token, and searches the database using the token 503.

Using the token the server retrieves the information in the database linked to the token 504. The server uses data from the token to display the page with the recent history of the text message to User2 (as routed by the server using the same app or browser), and the server displays User1's name or mobile phone number in the “From” field 505.

The server establishes a session using the permanent unique token in the URL 506. User2 can use the web page to reply to the message directly to User1. The server can use the deviceID or session token to route the message replied to User1. Alternatively, User2 can use User1's phone number to reply to User1 507.

User2's web page will also keep updating the server of the status of presence 508; the system can use web-sockets, polling or long polling to do this. Thus 2-way real-time communications are established between a User1 and a User2 on different platforms 509.

In another embodiment of the invention there may be more than two participants in this communication session. Thus the invention can be used for one-to-one communications as well as can be used for one-to-many communications. In certain embodiments, an existing thread could also be forwarded to a User3, or a User3 could be invited to join a session between User1 and User2.

In one embodiment of the invention once the 2-way communication session has been established between the first device that has an app and a second device that is using a browser, the content that is exchanged between the devices may preferably be text, picture, audio, video, hypertext, GPS location, or any other kind of digital content that can be shared or exchanged.

In one illustrative example, the present system and method could be used to send a multimedia file between users. User1 uploads a file to the server with the intention of sending it to User2. The server creates a unique token that contains the URL of the uploaded file, User2's DeviceID and User2's phone number. The server could then send this unique token to User1. User1 can send the unique token to User2 using SMS. User2 can then access the file using a browser. It will be appreciated that this method and system allows for a private, secure transmission of the file while bypassing MMS, which is expensive and may not always work cross country.

In a variation of an embodiment of the invention the content that is exchanged between the first device and the second device may be encrypted; the encryption may be either on the server side or the client side.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to persons skilled in the art.

The computer program comprises: a computer usable medium having computer usable program code, the computer usable program code comprises: computer usable program code for presenting graphically to the users options for a touch-screen interface.

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention.

The device may include but not limited to a personal computer (PC), which may include but not limited to a home PC, corporate PC, a Server, a laptop, a Netbook, a Mac, a cellular phone, a Smartphone, a PDA, an iPhone, an iPad, an iPod, an iPad mini, a PVR, a settop box, wireless enabled Blu-ray player, a TV, a SmartTV, wireless enabled Internet radio, e-book readers e.g. Kindle or Kindle DX, Nook, etc. and other such devices that may connect to the internet etc. The first device and the second device may be running any number of different operating systems as diverse as Microsoft Windows family, MacOS, iOS, any variation of Google Android, BlackBerry RIM, any variation of Linux or Unix, PalmOS, Symbian OS, Ubuntu or such operating systems used for such devices available in the market today or the ones that will become available as a result of the advancements made in such industries.

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of receiving an instant message from a first user on a device of a second user irrespective of the device's installed applications or the second user's online status, comprising:
receiving on the second user's device a text message addressed by the phone number of the device, the text message including a link with a permanent unique token;
actuating the link to establish a session of a dedicated web page on the second user's browser, the web page having a URL containing the permanent unique token, and displaying the instant message from the first user to the second user on the web page; and
permitting the second user to send a reply message to the first user via the web page.

2. The method of claim 1, wherein the instant message includes at least one of: a text component, a picture component, an audio component, a video component, a hypertext component, a multimedia component, and a GPS location component.

3. The method of claim 1, wherein the instant message is encrypted.

4. The method of claim 1, wherein the text message is SMS.

5. The method of claim 1, wherein the instant message includes more than 160 characters.

6. The method of claim 1, wherein the permanent unique token is embodied in an HTTP cookie that is stored on the second user's device.

7. The method of claim 1, wherein the session is kept alive as long as the second user is logged in to the browser.

8. The method of claim 1, wherein the session is kept alive until the second user ceases activity in the browser for a predetermined period of time.

9. The method of claim 1, further comprising displaying the first user's presence status on the web page on the second user's browser.

10. The method of claim 1, further comprising displaying a history of messages between the first user and the second user exchanged during the session.

11. The method of claim 10, wherein the messages are displayed as a continuous thread.

12. The method of claim 9, wherein the second user can send a push message to the first user through the web page if the first user is not present.

13. The method of claim 12, wherein the push message is sent to an instant messaging application on the first user's device.

14. A server for enabling communication of an instant message from a first user to a device of a second user irrespective of the device's installed applications or the second user's online status, the server including programmed instructions for:
receiving data from an app on the first user's device including an instant message to be sent to a second user, the data including a phone number of a device of the second user;
creating a permanent unique token for the second user;
sending a text message to the second user with a URL containing the permanent unique token;
allowing the second user to access a dedicated web page with the URL;
displaying the instant message on the web page; and
allowing the second user to send a reply to the first user via the web page.

15. The server of claim 14, further comprising looking up the phone number of the device in a database and if not found then creating an account using the phone number and the permanent unique token.

16. The server of claim 14, wherein sending a text message includes sending a push notification.

17. The server of claim 14, wherein sending a text message includes sending a message to an application on the second user's device.

18. The server of claim 17, wherein the application is a browser.

9. The server of claim 17, further comprising checking that the application is installed on the second user's device prior to sending a message to the application.

20. The server of claim 17, further comprising checking that the second user is online or that the application is open prior to sending a message to the application.

21. The server of claim 14, wherein the contents of the instant message are not part of the text message.

22. The server of claim 14, wherein receiving from an app comprises receiving an uploaded file.
